(19) United States
(12) Patent Application Publication
(10) Pub. No.: US 2021/0142460 A1
(43) Pub. Date: May 13, 2021

(54) METHOD FOR PERFORMING MICRO-SCALE SCANNING OF RAIL NETWORKS

(71) Applicant: Quantum Spatial, Inc., St. Petersburg, FL (US)

(72) Inventor: David Brandt, Portland, OR (US)

(21) Appl. No.: 17/096,875

(22) Filed: Nov. 12, 2020

Related U.S. Application Data
(60) Provisional application No. 62/934,409, filed on Nov. 12, 2019.

(51) Int. Cl. G06T 7/00; G06T 7/33

(52) U.S. Cl. CPC G06T 7/001; G06T 7/337; G06T 2207/30204; G06T 2207/10028; G06T 2207/30184; G06T 2207/30236

(57) ABSTRACT

Various embodiments are directed to a method for performing micro-scale scanning of rail networks. The method may include (i) scanning, by a sensor component, one or more railroad track sections including web markings at a submillimeter ranging resolution to capture three-dimensional (3D) depth image data, (ii) capturing, by a timing synchronization component coupled to the sensor component, location data, speed data, direction data, and timing data corresponding to the captured 3D depth image data, (iii) receiving, by a post-processing component, the 3D depth image data and the location data, speed data, direction data, and timing data from the sensor component and the timing synchronization component, and (iv) performing, by the post-processing component, a computer-implemented depth imagery analysis of the raw 3D depth image data to extract features corresponding to the web markings on the railroad track sections.

### CROSS-REFERENCE TO RELATED APPLICATION

This application claims the benefit of U.S. Provisional Application No. 62/934,409, filed Nov. 12, 2019, the disclosure of which is incorporated, in its entirety, by this reference.

### TECHNICAL FIELD

Embodiments of the disclosure relate generally to the scanning of rail networks and more specifically to a method for performing close proximity rail scanning and analysis to index rail track manufacturing attributes.

### BACKGROUND

Rail transportation companies often utilize various unit trains for carrying out passenger and/or freight operations (e.g., the transportation of perishable and non-perishable cargo) to reach any number of destinations over rail networks consisting of thousands of miles of railroad track. For example, just in the United States of America alone, there are over 140,000 miles of standard-gauge railroad track. As rail networks age over time (e.g., due to train use and natural decay), existing railroad track may often require maintenance and/or replacement. In order to facilitate maintenance operations, rail technicians typically identify various track attributes prior to performing track repairs and replacements across a rail network. For example, rail technicians may manually inspect various sections of track (and thereby temporarily closing one or more portions of a rail network to train traffic) to identify “web” markings (i.e., symbols and/or abbreviations commonly affixed to railroad tracks that provide information with respect to a specific rail section's weight, placement, mill brand, roll date, and method of hydrogen elimination, heat number, rail position letter, and strand/bloom number). The web markings may then be utilized to identify track replacement options and/or a plan for track maintenance during repair operations.

Traditional web marking inspection methods however, suffer from a number of drawbacks. For example, as track sections age over time, web marking symbols (which are typically represented by subtle raised edges in the steel making up railroad track), are often difficult to detect due to degradation caused by natural decay in the dynamic and jarring environment of trains traversing track sections at moderate to high speeds. As a result, manual inspection is often difficult and time consuming, resulting in increased downtime in a rail network. Other inspection methods, such as those utilizing cameras coupled to a light source as sensors to better capture web markings have also been found to be deficient due to the light source generating shadows which interfere with the detection of symbols on sections of track. In addition, the aforementioned camera sensor methods (along with other methods including, without limitation, traditional photogrammetry, structured light imaging, flash light detection and ranging (LiDAR), and disparity imaging) lack the precision needed to detect degraded web markings in which the character relief for the various symbols may often be less than one millimeter in depth and no more than one centimeter in width. It is with respect to these considerations and others that the various embodiments of the present invention have been made.

### SUMMARY

As will be described in greater detail below, the instant disclosure generally relates to a method for performing micro-scale scanning of rail networks. In one example, the method may include (i) scanning, by a sensor component, one or more railroad track sections including web markings at a submillimeter ranging resolution to capture three-dimensional (3D) depth image data, (ii) capturing, by a timing synchronization component coupled to the sensor component, location data, speed data, direction data, and timing data corresponding to the captured 3D depth image data, (iii) receiving, by a post-processing component, the 3D depth image data and the location data, speed data, direction data, and timing data from the sensor component and the timing synchronization component, and (iv) performing, by the post-processing component, a computer-implemented depth imagery analysis of the raw 3D depth image data to extract features corresponding to the web markings on the railroad track sections.

In some examples, the sensor component may include a time-of-flight sensor. In one example, the time-of-flight sensor may be a laser diode configured to scan a very small area with a short pulse duration.

In some examples, the timing synchronization component may include a multi-constellation global navigation satellite system (GNSS) receiver. In some examples, the railroad track sections comprise one or more sections of degraded railroad track.

In some examples, the web markings may include a group of symbols corresponding to one or more railroad track attributes. The railroad track attributes may include one or more of the following: weight information, section identification information, method of hydrogen elimination information, mill brand information, roll date information, heat number information, rail position letter information, and strand/bloom number information.

In some examples, the method may further include performing, by an optical character recognition (OCR) component, character recognition on the web markings for use in a system for indexing track manufacturing attributes for a rail network.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE FIGURES

FIG. 1 illustrates a block diagram of an example system that may be utilized in accordance with various embodiments.

FIG. 2 illustrates a block diagram of a section of railroad track with web marking symbols, in accordance with an example embodiment.

FIG. 3 illustrates a block diagram of web markings on a degraded section of railroad track before and after post-processing by the system of FIG. 1, in accordance with various embodiments.

FIG. 4 is a flow diagram illustrating an example method that may be utilized in accordance with various embodiments.

### DETAILED DESCRIPTION

The present disclosure describes a method for performing micro-scale scanning of web markings on track sections in rail networks. In some examples, the method may utilize a system that includes one or more sensor components having a short pulse duration and yielding range resolutions of around 20 micrometers such that a clear depth image of rail track may be collected. For example, a system configured according to one embodiment, may include sensor components for detecting (e.g., scanning) degraded web markings such that web marking symbols may be clearly identified in addition to track surface deformity. The collected results (which may consist of crisp clearly identifiable characters and/or symbols) may then be fed into a standard optical character recognition (OCR) model thereby allowing for quick turn-around results with minimum data manipulation. Utilizing the OCR model results, rail network technicians may be able to build a comprehensive plan for managing rail track repairs and replacements across an entire multi-state rail network thereby potentially decreasing track maintenance downtime and resulting in fewer accidents due to damaged rail sections.

Embodiments of the disclosure now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

FIG. 1 illustrates a block diagram of an example railroad track micro-scale scanning system 100 (hereinafter, the “system 100”). In some examples, the system 100 may include a sensor component 110 coupled to a timing synchronization component 120. In some examples, sensor component 110 may be utilized to scan multiple railroad track sections (such as railroad track section 160), portions of which may include web markings. In some embodiments, sensor component 110 may include a three-dimensional (3D) time-of-flight sensor 115. Time-of-flight sensor 115 may include a laser diode capable of scanning a very small area (e.g., an area less than a millimeter) with a short pulse duration. In one embodiment, the laser diode in time-of-flight sensor 115 may be incorporated into a scanner having a submillimeter ranging resolution (e.g., a resolution of around 20 micrometers) that captures 3D depth image data 130 of one or more track section samples from railroad track section 160. In some embodiments, 3D depth image data 130 may include both unbranded (i.e., unmarked) track sections in addition to branded track sections (i.e., marked with web markings).

In some examples, timing synchronization component 120 may operate in conjunction with sensor component 110 to record time of day and location data corresponding to 3D depth image data 130 of track section samples from railroad track section 160 scanned by time-of-flight sensor 115. In one example, timing synchronization component 120 may include a multi-constellation global navigation satellite system (GNSS) receiver 125 configured to capture location data, speed data, direction data, and timing data 135 as system 100 moves along railroad track section 160 collecting (e.g., capturing) 3D depth image data 130. For example, in one embodiment, portions of system 100 (e.g., sensor component 110 and timing synchronization component 120) may be incorporated as a specialized rig configured to traverse one or more sections of rail track (e.g., railroad track section 160) and collect scans thereof for the purpose of collecting 3D depth image data (e.g., raw data). In some examples, the rig may be attached to a moving railroad car for collecting 3D depth image data 130 (including web markings from degraded track sections) in real-time.

In some examples, system 100 may further include a post-processing component 140 in communication with sensor component 110 and timing synchronization component 120. In one embodiment, post-processing component 140 may For example, the post-processing component 140 may be a computing device having at least a hardware processor, a memory storage, and a network interface for receiving 3D depth image data 130 from sensor component 110 and collected GNSS data (i.e., location data, speed data, direction data, and timing data 135) from timing synchronization component 120. In some examples, post-processing component 140 may be capable of wireless and/or wireline communication with both sensor component 110 and timing synchronization component 120. For example, post-processing component 140 may be configured to receive 3D depth image data 130 as raw data from sensor component 110 and further receive location data, speed data, direction data, and timing data 135 from timing synchronization component 120, via a wireless receiver configured to receive wireless data from one or more wireless transmitters coupled to sensor component 110 and timing synchronization component 120.

In some examples, post-processing component 140 may store program code configured to execute one or more computer-executable instructions for performing various tasks including performing computer depth imagery analysis of 3D depth image data 130 to extract web marking features 145 corresponding to railroad track web markings. In one example, the program code may be configured to examine 3D depth image data 130 for various sections of rail track (e.g., railroad track section 160) to identify those sections containing web marking symbols and further identify, from among the web marking symbols, various track attributes including, but not limited to, weight information, section identification (i.e., placement) information, method of hydrogen elimination information, mill brand information, month and year of manufacture (i.e., roll date) information, heat number information, rail position letter information, and strand/bloom number information. For example, FIG. 2 shows a track section 200 including web marking symbols 210 corresponding to one or more of the aforementioned track attributes, FIG. 3 shows web marking symbols 315 in raw data 310 (i.e., 3D depth mage data 130) from a degraded section of railroad track, and FIG. 4 shows example computer depth imagery analysis results 320 of 3D depth image data 130, performed by post-processing component 140, to extract web marking symbols 325.

FIG. 4 is a flow diagram of an example method 400 for performing micro-scale scanning of rail networks. As illustrated in FIG. 4, at step 402 one or more of the systems described herein (e.g., system 100 of FIG. 1) may scan, by a sensor component, one or more railroad track sections including web markings at a submillimeter ranging resolution to capture three-dimensional (3D) depth image data. For example, sensor component 110 of FIG. 1 may utilize time-of-flight sensor 115 to scan railroad track section 160 to capture 3D depth image data 130 (e.g., raw data).

At step 404, one or more of the systems described herein may capture, by a timing synchronization component coupled to the sensor component, location data, speed data, direction data, and timing data corresponding to the captured 3D depth image data. For example, timing synchronization component 120 of FIG. 1 (which is coupled to sensor component 110) may utilize GNSS receiver 125 to capture location data, speed data, direction data, and timing data 135 corresponding to captured 3D depth image data 130. As discussed above with respect to FIG. 1, sensor component 110 and timing synchronization component 120 may be incorporated as a specialized rig configured to traverse one or more sections of rail track (e.g., railroad track section 160) and collect scans thereof for the purpose of collecting 3D depth image data 130 as raw data. In some examples, the rig may be attached to a moving railroad car for collecting 3D depth image data 130 (including web markings from degraded track sections) in real-time.

At step 406, one or more of the systems described herein may receive, by a post-processing component, the 3D depth image data and the location data, speed data, direction data, and timing data from the sensor component and the timing synchronization component. For example, post-processing component 140 of FIG. 1 may receive 3D depth image data 130 from sensor component 110 and location data, speed data, direction data, and timing data 135 from timing synchronization component 120. In some examples, post-processing component 140 may receive the aforementioned data wirelessly via a wireless receiver configured to receive wireless data from one or more wireless transmitters coupled to sensor component 110 and timing synchronization component 120.

At step 408, one or more of the systems described herein may perform, by the post-processing component, a computer-implemented depth imagery analysis of the raw 3D depth image data to extract features corresponding to the web markings on the railroad track sections. For example, post-processing component 140 may perform a computer-implemented depth imagery analysis of 3D depth image data 130. In some examples (and as described above with respect to FIG. 1, post-processing component 140 may store program code configured to execute one or more computer-executable instructions for performing various tasks including performing computer depth imagery analysis of 3D depth image data 130 to extract web marking features 145 corresponding to railroad track web markings. In one example, the program code may be configured to examine 3D depth image data 130 for various sections of rail track (e.g., railroad track section 160) to identify those sections containing web marking symbols and further identify, from among the web marking symbols, various track attributes including, but not limited to, weight information, section identification (i.e., placement) information, method of hydrogen elimination information, mill brand information, month and year of manufacture (i.e., roll date) information, heat number information, rail position letter information, and strand/bloom number information.

In some examples, the information from web marking features 145 may be utilized by a rail network to index track manufacturing attributes and further utilized to map track asset state, age, and origin information in a system for progressively building a network snapshot for all of a rail network's track. In some examples, system 100 may further include an optical character recognition (OCR) module 150 for receiving the results from post-processing component 140. In some examples, the OCR module 150 may function as a model for performing character recognition on web marking symbols so that they may be utilized in a system for the indexing of track manufacturing attributes for a rail network.

The terms “rail track,” “railroad track,” and “railway track” as used herein, generally refers to a structure consisting of rails, fasteners, ties and/or ballast as well as an underlying subgrade for enabling trains to move by providing a surface for their wheels to roll upon. During formation, railroad tracks begin as molten steel that is rolled and cooled prior to being cut to a requested length. Railroad tracks may also be given a marking or brand on the “web” portion of the track (i.e., the web marking) which may often be seen as subtle raised edges on steel track. The web is the narrow section of the track, located between the top or “head” of the track and the bottom or “base.” The web marking may include several different symbols and abbreviations indicating a number of different attributes about a track. As discussed above, these attributes may include, without limitation, weight information, section identification (i.e., placement) information, method of hydrogen elimination information, mill brand information, roll date information, heat number information, rail position letter information, and strand/bloom number information. Thus, web markings are a fundamental vector for understanding a specific rail section's weight, placement, mill brand, roll date, method of hydrogen elimination, heat number, rail position letter, and strand/bloom number.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
scanning, by a sensor component, one or more railroad track sections including web markings at a submillimeter ranging resolution to capture three-dimensional (3D) depth image data;
capturing, by a timing synchronization component coupled to the sensor component, location data, speed data, direction data, and timing data corresponding to the captured 3D depth image data;
receiving, by a post-processing component, the 3D depth image data and the location data, speed data, direction data, and timing data from the sensor component and the timing synchronization component; and
performing, by the post-processing component, a computer-implemented depth imagery analysis of the 3D depth image data to extract features corresponding to the web markings on the railroad track sections.

2. The method of claim 1, wherein scanning the railroad track sections comprises utilizing a time-of-flight sensor in the sensor component to scan for the web markings.

3. The method of claim 2, wherein the time-of-flight sensor comprises a laser diode configured to scan a very small area with a short pulse duration.

4. The method of claim 1, wherein capturing the location data, speed data, direction data, and timing data comprises utilizing a multi-constellation global navigation satellite system (GNSS) receiver in the timing synchronization component to capture the location data, speed data, direction data, and timing data.

5. The method of claim 1, wherein the railroad track sections comprise one or more sections of degraded railroad track.

6. The method of claim 1, wherein the web markings comprise a plurality of symbols corresponding to one or more railroad track attributes.

7. The method of claim 6, wherein the railroad track attributes comprise:
weight information;
section identification information;
method of hydrogen elimination information;
mill brand information;
roll date information;
heat number information;
rail position letter information; and
strand/bloom number information.

8. The method of claim 1, further comprising performing, by an optical character recognition (OCR) component, character recognition on the web markings for use in a system for indexing track manufacturing attributes for a rail network.

9. A method for performing railroad track micro-scale scanning, comprising:
scanning, by a sensor component, one or more railroad track sections including web markings at a submillimeter ranging resolution to capture three-dimensional (3D) depth image data;
capturing, by a timing synchronization component coupled to the sensor component, location data, speed data, direction data, and timing data corresponding to the captured 3D depth image data;
receiving, by a post-processing component, the 3D depth image data and the location data, speed data, direction data, and timing data from the sensor component and the timing synchronization component;
performing, by the post-processing component, a computer-implemented depth imagery analysis of the 3D depth image data to extract features corresponding to the web markings on the railroad track sections; and
performing, by an optical character recognition (OCR) component, character recognition on the web markings for use in a system for indexing track manufacturing attributes for a rail network.

10. The method of claim 9, wherein scanning the railroad track sections comprises utilizing a time-of-flight sensor in the sensor component to scan for the web markings.

11. The method of claim 10, wherein the time-of-flight sensor comprises a laser diode configured to scan a very small area with a short pulse duration.

12. The method of claim 9, wherein capturing the location data, speed data, direction data, and timing data comprises utilizing a multi-constellation global navigation satellite system (GNSS) receiver in the timing synchronization component to capture the location data, speed data, direction data, and timing data.

13. The method of claim 9, wherein the railroad track sections comprise one or more sections of degraded railroad track.

14. The method of claim 9, wherein the web markings comprise a plurality of symbols corresponding to one or more railroad track attributes.

15. The method of claim 14, wherein the railroad track attributes comprise weight information.

16. The method of claim 14, wherein the railroad track attributes comprise section identification information.

17. The method of claim 14, wherein the railroad track attributes comprise method of hydrogen elimination information.

18. The method of claim 14, wherein the railroad track attributes comprise mill brand information.

19. The method of claim 14, wherein the railroad track attributes comprise date information.

20. The method of claim 14, wherein the railroad track attributes comprise rail position letter information.
